(19) United States
(12) Patent Application Publication
(10) Pub. No.: US 2019/0062133 A1
(43) Pub. Date: Feb. 28, 2019

(54) SCISSOR JACK

(71) Applicant: Ford Global Technologies LLC, Dearborn, MI (US)

(72) Inventors: Wendy Ge, Nanjing (CN); Brenna Liu, Nanjing (CN); Han Zhou, Nanjing (CN); Zhuang Xu, Nanjing (CN)

(21) Appl. No.: 16/008,862

(22) Filed: Jun. 14, 2018

(30) Foreign Application Priority Data
Aug. 24, 2017 (CN) 201710733130.X

(51) Int. Cl. B66F 3/12

(52) U.S. Cl. CPC B66F 3/12

(57) ABSTRACT

A scissor jack comprises a support member coupled to a first upper arm and a second upper arm; a base coupled to a first lower arm and a second lower arm; a first connector pivotally connected to the first upper arm and the first lower arm; a second connector pivotally connected to the second upper arm and the second lower arm; a lead screw fixed to the first connector; and a driving member having a first through-hole. The driving member is rotatable connected in the second connector and the lead screw is connected with the first through-hole via thread connection.

### RELATED APPLICATION

This application claims the benefit of Chinese Patent Application No.: CN 201710733130.X filed on Aug. 24, 2017, the entire contents thereof being incorporated herein by reference.

### FIELD

The present disclosure relates to a jack, specifically relates to a scissor jack.

### BACKGROUND

A jack such as a scissor jack is typically provided in a vehicle to lift the vehicle when needed. A lead screw head of the scissor jack is usually made from a forging process, which is expensive in tooling and processing. Various jacks are developed to lower the manufacturing cost. The CN200420076640.2 discloses a bridge jack with a rotatable screw nut. The jack is lifted up and down via rotation of a screw nut sleeved on a lead screw. However, the force required to rotate the screw nut can be great at a high load. Further, the lead screw extends a long distance outside when the jack is lifted to a higher position.

### SUMMARY

According to one aspect of the present disclosure, a jack is provided. The jack comprise a support member coupled to a first upper arm and a second upper arm; a base coupled to a first lower arm and a second lower arm; a first connector pivotally connected to the first upper arm and the first lower arm; a second connector pivotally connected to the second upper arm and the second lower arm; a lead screw fixed to the first connector; and a driving member having a first through-hole. The driving member is rotatably connected with the second connector and the lead screw is connected with the first through-hole of the driving member via thread connection.

In one embodiment, the second connector may include a second through-hole extending along a lengthwise direction of the lead screw and configured to receive the driving member.

In another embodiment, the driving member may include a middle portion disposed in the second through-hole, a support portion extend from the middle portion toward the first connector, and a driving portion extending from the middle portion in a direction away from the first connector. The middle portion, the support portion and the driving portion may be integrally formed.

In another embodiment, the support portion of the driving member ay include an inner thread and the lead screw may include may an outer thread matching the inner thread of the support portion.

In another embodiment, an edge portion of the lead screw may overlap with an edge portion of the support member when a height between the supporting member and the base is minimum,

In another embodiment, a cross section of the middle portion and a cross section of the support portion of the driving member may have an annular shape, and the driving portion may protrude radially relative to the middle portion and includes an outer cross section matching a driving handle.

In another embodiment, the driving portion may include a cross section area having a hexagon shape and the driving member is formed by cold extrusion.

In another embodiment, the jack may further comprise a bearing disposed between the driving member and the second connector.

In another embodiment, the jack may further comprise a bearing disposed between the middle portion of the driving member and the second through-hole of the second connector.

In another embodiment, the driving member may further include a stop positioned on an outer surface of the support portion at a radial direction and abutting the second connector to prevent movement of the driving member relative to the second connector along a lengthwise direction of the lead screw.

In another embodiment, an outer surface of the support portion may include a groove and the stop is a snap ring embedded into the groove.

In another embodiment, the lead screw may include a threaded portion and a smooth rod portion and a height limiting portion adjacent the threaded portion and extending radially from the smooth rod portion. The height limiting portion may contact an end of the support portion when a height between the support member and the base is maximum.

In another embodiment, the first connector may include a third through-hole, the lead screw includes a first end extending through the third through-hole and disposed outside the first connector. A cross sectional shape of an outer surface of the lead screw and a cross sectional shape of the third through-hole may be configured to prevent relative movement of the lead screw in the third through-hole. The lead screw may include a stop extending from the first end of the lead screw.

According to another aspect, a scissor jack is provided. The scissor jack comprises a first connector to connect a first upper arm and a second lower arm; a second connector to connect a second upper arm and a second lower arm; a lead screw fixed to the first connector a driving member connected to the second connector. The driving member is a hollow pipe, includes a middle portion disposed in the second connector, a support portion extending from the middle portion toward the first connector, and a driving portion extending from the middle portion away from the first connector. The support portion of the driving member includes an inner thread matching the lead screw, and a cross section of the driving portion is greater than a cross section of the middle portion and the driving member is integrally formed by cold extrusion. At least a portion of the support portion of the driving member is connected with the lead screw, a rotation of the driving portion along the lead screw at a first direction enable a decreased distance between the first connector and the second connector and a rotation of the driving portion along the lead screw at a second direction enables an increased distance between the first connector and the second connector.

In one embodiment, the scissor jack may further include a bearing to support rotation of the driving member in the second connector.

In another embodiment, the first connector may include a through-hole, the lead screw includes a connection portion disposed inside the through-hole of the first connector and a first end passing through the through-hole and disposed outside the first end at a direction away from the second connector. The through-hole may have a square shape and a cross section of the connection portion has a square shape.

According to another aspect, a scissor jack assembly is provided. The scissor jack assembly comprises a scissor jack and a driving handle. The scissor jack comprises a support member, a first upper arm and a second upper arm coupled to the support member, a base, a second upper arm and a second lower arm coupled to the base, a first connector pivotally connected to the first upper arm and the first lower arm, a second connector pivotally connected to the second upper arm and the second lower arm, a lead screw fixed to the first connector, and a driving member rotatably connected to the second connector. The driving member includes a support portion having an inner thread and a driving portion. A portion of the lead screw is engaged with the support portion of the driving member. The driving handle includes a sleeve portion to actuate the driving member, and the sleeve portion includes an opening. The opening of the sleeve portion is aligned with a first through-hole when the sleeve portion is engaged with the driving portion.

In one embodiment, the driving handle may further include a lever pivotally connected to the sleeve portion.

In another embodiment, an outer cross section of the driving portion of the jack may have a hexagon shape, and the sleeve portion of the driving handle may include a corresponding inner surface having a hexagon shape to facilitate an engagement between the driving portion and the driving handle.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1A schematically depicts a scissor jack according to one embodiment of the present disclosure, illustrating a support member of the jack at a lower position.

FIG. 1B depicts the jack in FIG. 1A, illustrating the support member of the jack at a maximum lifting position.

FIG. 2A schematically depicts an enlarged partial view of the jack in FIG. 1A, illustrating a first connect and a lead screw of the jack.

FIG. 2B shows a cross sectional view of the first connect and the lead screw in FIG. 2A.

FIG. 3A schematically depicts an enlarged partial view of the jack in FIG. 1A, illustrating the lead screw, a second connector and a driving member of the jack in FIG. 1A.

FIG. 3B schematically depicts a cross-sectional view of the lead screw, the second connector and the driving member of the jack in FIG. 3A.

FIG. 4 schematically shows a partial side view of a jack according to another embodiment of the present disclosure.

FIG. 5 schematically shows a perspective view of a driving member of a jack according to one embodiment of the present disclosure.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed jacks will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various jacks are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

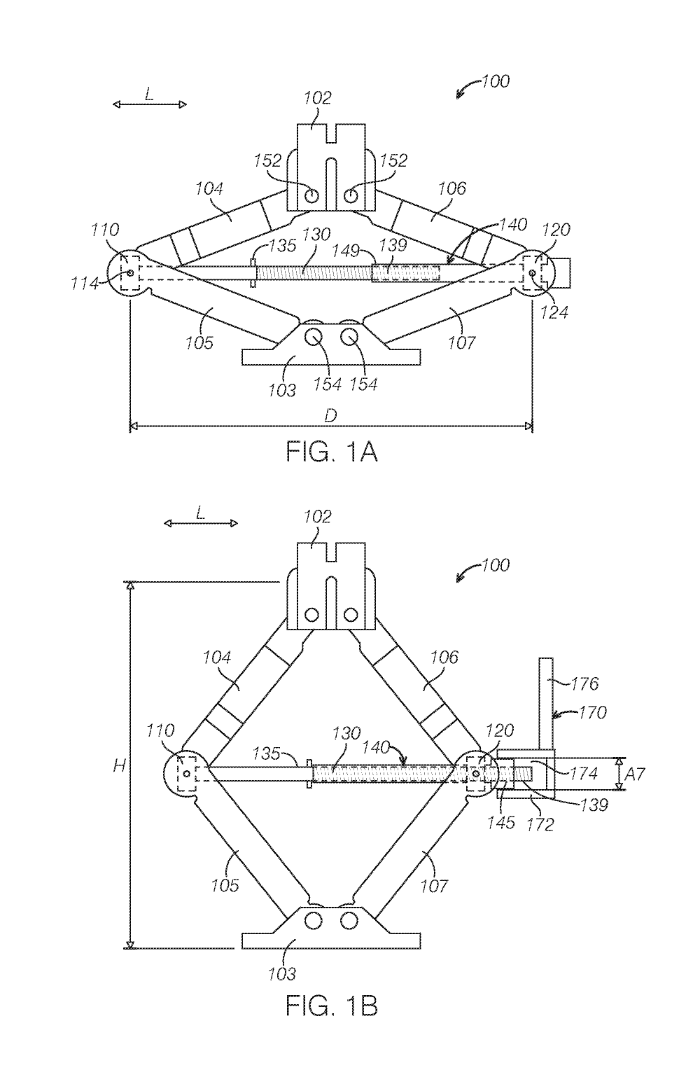

FIGS. 1A to 3B schematically depict a scissor jack 100 according to one embodiment of the present disclosure. The jack 100 comprises a support member 102, a base 103, a first upper arm 104, a first lower arm 105, a second upper arm 106, a second lower arm 107, a first connector 110, a second connector 120, a lead screw 130 and a driving member 140. One end of the lead screw 130 is attached to the first connector 110. The driving member 140 is partially disposed in the second connector 120 and is rotatable or the driving member 140 is rotatably connected with the second connector 120. The driving member 140 includes a first through-hole 142 and the lead screw 130 is connected to the first through-hole 142 via thread connection.

Referring to FIGS. 1A-1B, in some embodiments, the first upper arm 104 and the second upper arm 106 may be pivotally connected to the support member 102 via first rivets 152. As known in the art, an end of the first upper arm 104 and an end of the second upper arm 106 may be coupled each other via a tooth structure at the support member 102 (not shown). The first lower arm 105 and the second lower arm 107 may be pivotally connected to the base 103 via second rivets 154. At the base 103 or a place near the base 103, an end of the first lower arm 105 and an end of the second lower arm 107 are coupled via a tooth structure (not shown). Additionally, the first upper arm 104 and the first lower arm 105 may be pivotally connected to the first connector 110 via a pivot 114, and the second upper arm 106 and the second lower arm 107 may be pivotally connected to the second connector 120 via a pivot 124. As described in detail below, a height H between the support member 102 and the base 103 can be increased or decreased to realize the function of the jack when the driving member 140 is rotated to move the second connector 120 along the lead screw 130 toward or away from the first connector 110.

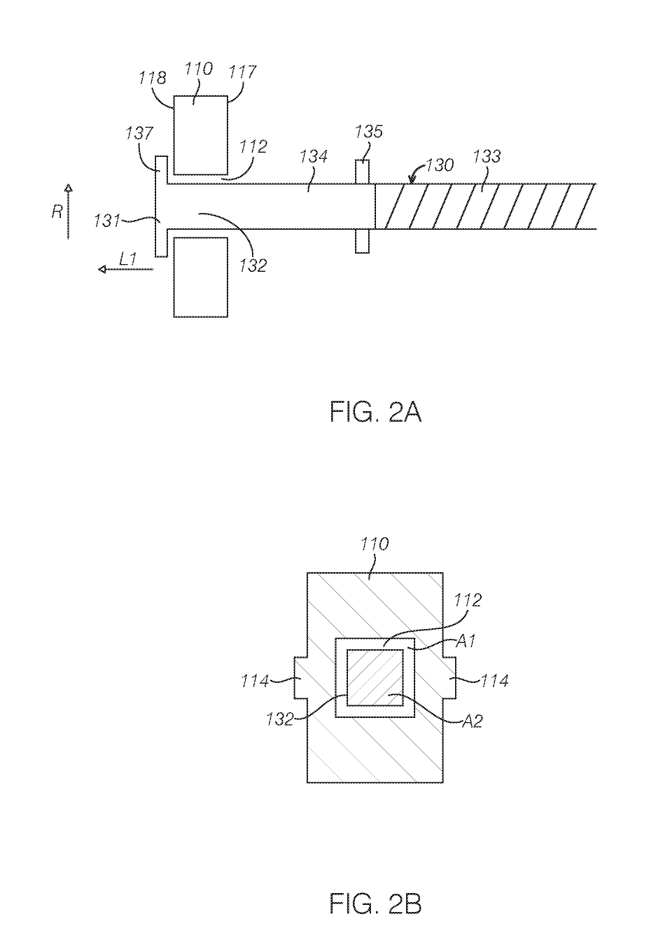

Referring to FIGS. 2A-B, the lead screw 130 is fixed to the first connector 110 to prevent rotation or translation of the lead screw 130 relative to the first connector 110. For the clarity of illustration, a clearance between the lead screw 130 and the first connector 110 is shown. In some embodiments, the first connector 110 may include a third through-hole 112 and the lead screw 130 may extend through the third through-hole 112 and drivably connected with the first connector 110. In other words, a cross-section Al of an inner surface of the third through-hole 112 and a across-section A2 of an outer surface of a connection portion 132 of the lead screw 130 may be configured to have corresponding shapes that prevent relative rotation of the lead screw 130 and the third through-hole 112. For example, the lead screw 130 may include aconnection portion 132 disposed in the third through-hole 112 of the first connector 110 and an end portion 131 disposed outside the first connector 110 at a direction L1 away from the second connector 120. The third through-hole 112 may be a square hole and a cross section A2 of the connection portion 132 may have a square shape matching the shape of the third through-hole 112. It will be appreciated that the cross sections of the third through-hole 112 and the connection portion 132 may have any appropriate shapes such as a rectangular, a triangle, a hexagon, and an oval or other regular or irregular shapes.

The first end portion 131 of the lead screw 130 may extend through the third through-hole 112 and positioned outside the first connector 110. A stop 137 may be formed at the first end portion 131 and extend at a radial direction R. The stop 137 may be integrally formed with the lead screw 130 or formed separately as a one piece and then connected to the lead screw 130. The stop 137 may be attached to an outer surface 118 of the first connector 110 via any appropriate approaches such as welding, adhesive or snap connections. The stop 137 can prevent translation of the lead screw 130 relative to the first connector.

In some embodiments, the lead screw 130 may be fixed to the first connector 110 via any appropriate approaches such as welding, snap or adhesive connection.

In some embodiments, the lead screw 130 may include a smooth rod portion 134 between a threaded portion 133 and the stop 137. The smooth rod portion refers to a portion without threads. The lead screw 130 may further include a height limiting portion 135 to limit a height of the support member 102 relative to the base 103. The height limiting portion 135 may extend at the radial direction R from a position at the smooth rod portion 134 that is adjacent to the threaded portion 133. As shown in FIG. 1B, the height limiting portion 135 may contact an end of a support portion 143 of the driving member 140 when the jack 100 is at the maximum lifting position or a height II between the support member 102 and the base 103 is maximum. At the maximum lifting position, further lifting is restricted to avoid the exceedance of the use limitation. In some embodiments, the lead screw 130 may only include a threaded portion 133 without the smooth rod portion and the height limiting portion 135 may be formed on the threaded portion 131 Alternatively, the height limiting portion may be omitted whereas the lifting height is restricted when a surface 117 of the first connector 110 contacts a support portion 143 of the driving member 140.

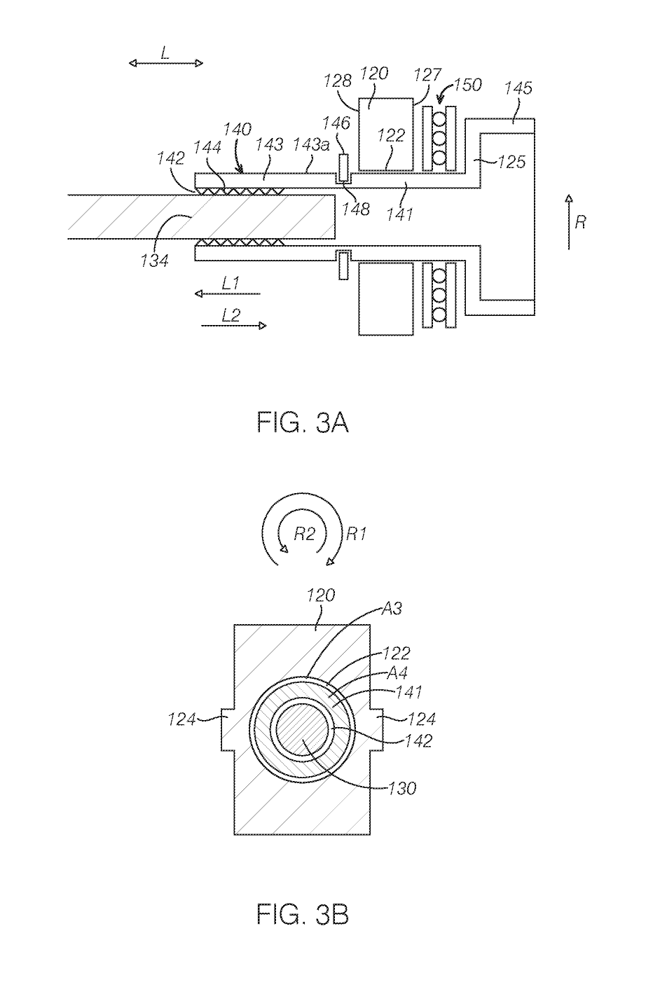

Referring to FIGS. 3A-3B, a second connector 120 and a driving member 140 of the jack 100 are illustrated according to one embodiment of the present disclosure. The second connector 120 includes a second through-hole 122 extending along a lengthwise direction L of the lead screw 130. The driving member 140 is partially received in the second through-hole 122. The driving member 140 may include a middle portion 141, a support portion 143 and a driving portion 145. The middle portion 141 is at least partially positioned in the second through-hole 122, the support portion 143 extends from an end of the middle portion 141 and faces the first connector 110 at the first direction L1 parallel the lengthwise direction L, and the driving portion 145 extends from another end of the middle portion 141 at a second direction L2 opposing the first direction L1. In other words, at the lengthwise direction L, the second connector 120 is positioned between the support portion 143 and the driving portion 145. The driving portion 145 may protrude at a radial direction R relative to the middle portion 141. The middle portion 141, the support portion 143 and the driving portion 145 may be integrally formed via a cold extrusion process.

The driving member 140 may be rotatably received in the second through-hole 122 of the second connector 120. For example, both a cross section A3 of the second through-hole 122 and a cross section A4 of the middle portion 141 may have annular shapes. Additionally or alternatively, the jack 100 may further include a bearing 150 to support rotation of the driving member 140 inside the second connector 120. In the embodiment depicted in FIG. 3A, the bearing 150 may be positioned between a bottom wall 125 of the driving portion 145 of the driving member 140 and an outer surface 127 of the second connector 120. In one example, the bottom wall 125 of the driving portion 145 is substantially perpendicular to the lengthwise direction L. For the clarity of illustration, the hearing 150 is shown to have a clearance with the second connector 120 and a clearance with the driving portion 145. It will be appreciated that the bearing 150 may abut the second connector 120 and the driving portion 145 to facilitate smooth rotation between the second connector 120 and the driving portion 140. Further, the bearing 150 may prevent the driving member 140 to move right relative to the second connector at the direction L as shown in FIG. 3A.

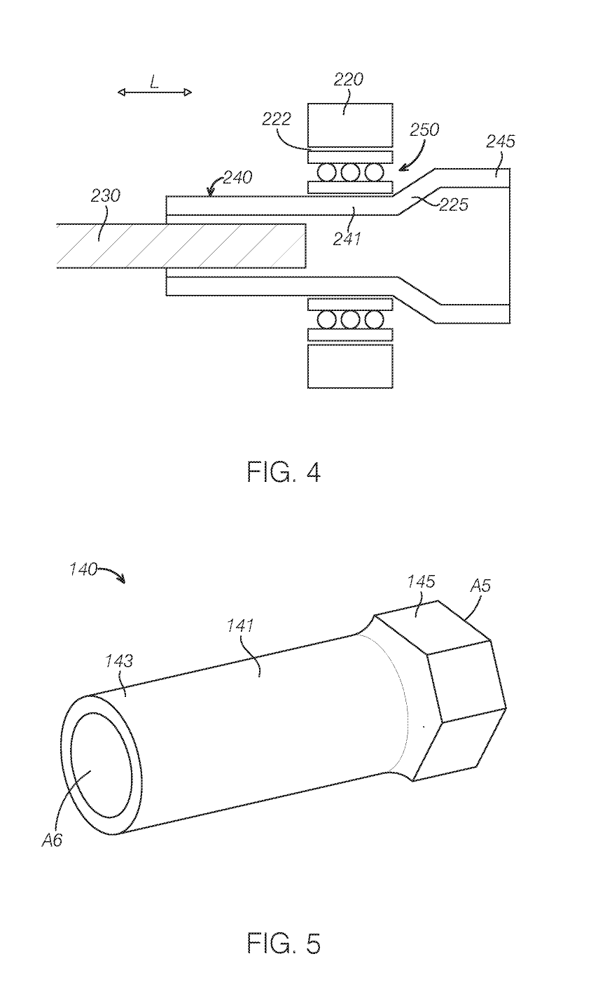

In another embodiment illustrated in FIG. 4, a bearing 250 is disposed between a middle portion 241 of a driving member 240 and a second through-hole 222 of a second connector 220 to support rotation of the driving member 240 relative to the second connector 220. Similar to the embodiment in FIG. 3A, the lead screw 230 is connected to the driving member 240 via thread. For the clarity of illustration, the bearing 250 is shown to have a clearance with the second connector 220 and a clearance with the middle portion 241. It will be appreciated that the bearing 250 may abut or directly contact the second connector 220 and the middle portion 241 to facilitate smooth rotation between the second connector 120 and the driving member 140 and prevent translation at the direction L. In the depicted embodiment, an angle of a bottom 225 of the driving portion 245 to the lengthwise direction L is less than 90 degrees.

Continuing with FIG. 3A, the support portion 143 of the driving member 140 extends toward the first connector 110 from the middle portion 141 and is positioned between the first connector 110 and the second connector 120. A stop 146 may be disposed at an outer surface of the support portion 143 at the radial direction R to be adjacent to a side surface 128 of the second connector 120. For clarity of illustration, the stop 146 is shown to have a clearance with the side surface 128 of the second connector 120. It will be appreciated that the stop 146 may directly contact the side surface 128 of the second connector 120 to prevent the driving member 140 to move left relative to the second connector 120. In some embodiments, a groove 148 may be formed on an outer surface 143a of the support portion 143, and the stop 146 may be formed as a snap ring and embedded in the groove 148. In other embodiment, the stop 146 may be fixed to the support portion 143 of the driving member 140 via appropriate connections such as welding, adhesive connection or is integrally formed with the support portion 143.

Continuing with FIG. 3A and with further reference to FIGS. 1A-1B, the support portion 143 has a predetermined length to partially receive the lead screw 130. At least a portion of the support potion 143 may include an inner thread 144 and the lead screw 130 may have an outer thread 134 matching the inner thread 144. When the driving member 140 is rotated, an engagement of the inner thread 144 and the outer thread 134 enables the movement of the lead screw 130 relative to the driving member 140 at the direction L and thus change a distance or height H between the support member 102 and the base 103 via the first upper arm, the second upper arm, the first lower arm and the second lower arm.

For example, when the driving member 140 is rotated at a first direction R1, the engagement of the inner thread 144 and the outer thread 134 makes the lead screw 130 move right relative to the driving member 140. As the lead screw 130 is fixed to the first connector 110 and the movement/translation of driving member 140 relative to the second connector 120 is restricted at the direction L, a distance D between the first connector 110 and the second connector 120 is decreased, which results in an increased height H between the support member 102 and the base 103. Thus, the upper lifting position of the jack 100 is changed. When the height limiting stop 135 contacts an end of the support portion 143 of the driving member 140 as shown in FIG. 19, the jack is at the maximum lifting position, that is, the height between the support member 102 and the base is maximum.

In contrast, when the driving member 140 is rotated along a second direction R2 opposing the first direction RI, an engagement of the inner thread 144 and the outer thread 134 makes the lead screw move left relative to the driving member 140. As the lead screw 130 is fixed to the first connector 110 and the translation of the driving member 140 relative to the second connector 120 at the direction L is restricted, a distance D between the first connector 110 and the second connector 120 is increased, which results in a decreased height H between the support member 102 and the base 103, and thus the jack 100 is changed toward a stowed position. At the position shown in FIG. 1A, the jack 100 is at a lowest position, that is, the height H between the support member 102 and the base 103 is minimum. An edge portion 139 of the lead screw 130 is overlapped with an edge portion 149 of the support portion 143. In other words, at the lowest position of the jack 100, a portion of the lead screw 130 is still received in the driving member 140.

The jack of the present disclosure is advantageous in saving a space because the lead screw 130 can be configured to be shorter. Further, the lead screw 130 extends a smaller length outside the driving member 140 at the maximum lifting position. In this way, driving handle 170 as shown in FIG. 1B can be used to engage the driving portion 145 to operate the jack 100.

Referring to FIG. 5, in some embodiments, the driving portion 145 of the driving member 140 may have an outer cross section A5 matching a driving handle 170, such as a cross section having a hexagon shape. The middle portion 141 and the support portion 143 may have an annular cross section A6. In one example, the driving member 140 may be a hollow pipe, including the middle portion 141at least partially received in the second connector 120 with which it is rotatably connected, the support portion 143 to receive the lead screw 130 and the driving portion 145. The outer cross section A5 of the driving portion 145 is greater than the cross section A6 of the middle portion 141. The middle portion 141, the support portion 143 and the driving portion 145 may be formed integrally by any appropriate approaches such as the cold extrusion, hole expansion and hole reduction processes. Alternatively, the middle portion 141, the support portion 143 and the driving portion 145 may be formed separately and then connected together.

Referring to FIG. 1B, corresponding to the driving portion 145 of the jack 100, the driving handle 170 may have a sleeve portion 172 to drive the driving portion 145. The sleeve portion 172 may include an opening 174 having a predetermined length. When the sleeve portion 172 engages the driving portion 145, the opening 174 aligns with the first through-hole 142 of the support portion 143 of the driving member 140. In this way, an end of the lead screw 130 passes through the first through-hole 142 and moves toward the second connector 120 when the jack 100 is driven to a higher position. When the support member 102 is at a certain height, an edge portion end 139 of the lead screw 130 may extend into the opening 174. In other words, the opening 174 aligned with the first through-hole 142 can ensure a space for the movement of the lead screw 130 to avoid the contact of the lead screw 130 with the driving handle 170. The driving handle 170 having the opening 174 with a certain length allow passing through of the lead screw 130 when the support member 102 is lifted to a certain height and thus still enables the operation of the jack via the driving handle at such position.

The sleeve portion 172 may have an inner cross section A7 corresponding the outer cross section AS of the driving portion 145. For example, the driving portion 145 may have the outer cross section AS of a hexagon shape and the sleeve portion 172 may have the inner cross section A7 of a hexagon shape. In this way, the sleeve portion 172 may enclose on the driving portion 145 and actuate the driving portion 145 to rotate. In other embodiments, the sleeve portion 172 and the driving portion 145 may have any appropriate corresponding shapes such as a triangle, a square and an oval.

Further, the driving handle 170 may include a lever 176. The lever 176 may be pivotally connected to the sleeve portion 172 to provide a foldable structure to facilitate the storage in a vehicle.

As one end of the lead screw of the present disclosure is a fixed part, there is no need to form a screw nut a hexagon head) at the lead screw to match the driving handle and thus eliminate the expensive forging process. According to the embodiment of the present disclosure, a driving member rotatably connected to the lead screw is provided with a driving portion matching the driving handle. The driving member may be formed integrally by the processes such as cold extrusion, hole expansion and hole reduction processes and thus have lower tooling and manufacturing cost. Further, it is easy for a user to operate the jack by the driving handle.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

The invention claimed is:

1. A jack, comprising:
a support member coupled to a first upper arm and a second upper arm;
a base coupled to a first lower arm and a second lower arm;
a first connector pivotally connected to the first upper arm and the first lower arm;
a second connector pivotally connected to the second upper arm and the second lower arm;
a lead screw fixed to the first connector; and
a driving member having a first through-hole,
wherein the driving member is rotatably connected in the second connector and the lead screw is connected with the first through-hole via thread connection.

2. The jack of claim 1, wherein the second connector includes a second through-hole extending along a lengthwise direction of the lead screw and configured to receive the driving member.

3. The jack of claim 2, wherein the driving member includes a middle portion disposed in the second through-hole, a support portion extend from the middle portion toward the first connector, and a driving portion extending from the middle portion in a direction away from the first connector, and wherein the middle portion, the support portion and the driving portion are integrally formed.

4. The jack of claim 3, wherein the support portion of the driving member includes an inner thread and the lead screw includes an outer thread matching the inner thread of the support portion.

5. The jack of claim 4, wherein an edge portion of the lead screw overlaps with an edge portion of the support member when a height between the supporting member and the base is minimum.

6. The jack of claim 3, wherein a cross section of the middle portion and a cross section of the support portion of the driving member have an annular shape, and wherein the driving portion protrudes radially relative to the middle portion and includes an outer cross section matching a driving handle.

7. The jack of claim 6, wherein the driving portion includes a cross section area having a hexagon shape and the driving member is formed by cold extrusion.

8. The jack of claim 3, further comprising a bearing disposed between the driving member and the second connector.

9. The jack of claim 3, further comprising a bearing disposed between the middle portion of the driving member and the second through-hole of the second connector.

10. The jack of claim 3, wherein the driving member further includes a stop positioned on an outer surface of the support portion at a radial direction and abutting the second connector to prevent movement of the driving member relative to the second connector along a lengthwise direction of the lead screw.

11. The jack of claim 10, wherein an outer surface of the support portion includes a groove and the stop is a snap ring embedded into the groove.

12. The jack of claim 3, wherein the lead screw includes a threaded portion and a smooth rod portion and a height limiting portion adjacent the threaded portion and extending radially from the smooth rod portion, and wherein the height limiting portion contacts an end of the support portion when a height between the support member and the base is maximum.

13. The jack of claim wherein the first connector includes a third through-hole, the lead screw includes a first end extending through the third through-hole and disposed outside the first connector, wherein a cross sectional shape of an outer surface of the lead screw and a cross sectional shape of the third through-hole are configured to prevent relative movement of the lead screw in the third through-hole, ands wherein the lead screw includes a stop extending from the first end of the lead screw.

14. A scissor jack, comprising:
a first connector to connect a first upper arm and a second lower arm;
a second connector to connect a second upper arm and a second lower arm;
a lead screw fixed to the first connector;
a driving member connected to the second connector, wherein the driving member is a hollow pipe, includes a middle portion disposed in the second connector, a support portion extending from the middle portion toward the first connector, and a driving portion extending from the middle portion away from the first connector, wherein the support portion includes an inner thread matching the lead screw, and a cross section of the driving portion is greater than a cross section of the middle portion and the driving member is integrally formed by cold extrusion,
wherein at least a portion of the support portion of the driving member is connected with the lead screw, a rotation of the driving portion along the lead screw at a first direction enable a decreased distance between the first connector and the second connector and a rotation of the driving portion along the lead screw at a second direction enables an increased distance between the first connector and the second connector.

15. The scissor jack of the claim 14, further comprising a bearing to support rotation of the driving member in the second connector.

16. The scissor jack of claim 14, wherein the first connector includes a through-hole, the lead screw includes a connection portion disposed inside the through-hole of the first connector and a first end passing through the through-hole and disposed outside the first end at a direction away from the second connector, and wherein the through-hole has a square shape and a cross section of the connection portion has a square shape.

17. A scissor jack assembly, comprising:
a scissor jack, comprising:
a support member,
a first upper arm and a second upper arm coupled to the support member,
a base,
a second upper arm and a second lower arm coupled to the base,
a first connector pivotally connected to the first upper arm and the first lower arm,
a second connector pivotally connected to the second upper arm and the second lower arm,
a lead screw fixed to the first connector, and
a driving member rotatably connected to the second connector, the driving member including a support portion having an inner thread and a driving portion, wherein a portion of the lead screw is engaged with the support portion of the driving member; and
a driving handle including a sleeve portion to actuate the driving member, wherein the sleeve portion includes an opening, wherein the opening is aligned with a first through-hole when the sleeve portion is engaged with the driving portion.

18. The scissor jack assembly of claim 17, wherein the driving handle further includes a lever pivotally connected to the sleeve portion.

19. The scissor jack assembly of claim 17, wherein an outer cross section of the driving portion of the jack has a hexagon shape, and the sleeve portion of the driving handle includes a corresponding inner surface having a hexagon shape to facilitate an engagement between the driving portion and the driving handle.
